(19) United States
(12) Patent Application Publication
(10) Pub. No.: US 2016/0273110 A1
(43) Pub. Date: Sep. 22, 2016

(54) DEPOSITION APPARATUS AND DEPOSITION METHOD

(71) Applicant: Kabushiki Kaisha Toshiba, Tokyo (JP)

(72) Inventors: Hiroshi Sanda, Kanazawa Ishikawa (JP); Eiichi Nagumo, Nonoichi Ishikawa (JP); Makoto Saito, Nomi Ishikawa (JP)

(21) Appl. No.: 14/843,729

(22) Filed: Sep. 2, 2015

(30) Foreign Application Priority Data
Mar. 16, 2015 (JP) 2015-052742

(51) Int. Cl. C23C 16/52; C23C 16/513

(52) U.S. Cl. CPC C23C 16/52; C23C 16/513

(57) ABSTRACT

According to one embodiment, a deposition apparatus includes a plasma gun, a detector, and a controller. The plasma gun is capable of ejecting a plasma gas, and is capable of forming a film on a work piece exposed to the plasma gas. The detector detects a temperature or a luminous intensity in the plasma gas in a direction of ejection of the plasma gas. The controller controls a distance between the work piece and the plasma gun based on the temperature or the luminous intensity obtained from the detector, so that the plasma gas has a temperature in a range from a first temperature to a second temperature or a luminous intensity in a range from a first luminous intensity to a second luminous intensity is irradiated to the work piece.

### CROSS-REFERENCE TO RELATED APPLICATIONS

This application is based upon and claims the benefit of priority from Japanese Patent Application No. 2015-052742, filed on Mar. 16, 2015; the entire contents of which are incorporated herein by reference.

### FIELD

Embodiments described herein relate generally to a deposition apparatus and a deposition method.

### BACKGROUND

A deposition apparatus is available that ejects a plasma gas from a plasma gun, and forms a film on a substrate exposed to the plasma gas. The plasma gas ejected from a plasma gun may not always have a uniform state, for example, a uniform plasma temperature, in the plasma. In this case, the quality and the deposition rate of the film may vary with the distance between the plasma gun and the substrate, and the device may fail to deposit a film in a repeatable fashion.

### BRIEF DESCRIPTION OF THE DRAWINGS

FIG. 1A and FIG. 1B are schematic views of relevant portions of a deposition apparatus according to a first embodiment;

FIG. 2 is a schematic view of a relevant portion of the deposition apparatus according to the first embodiment;

FIG. 3 is a graph showing exemplary characteristics of the deposition apparatus according to the first embodiment;

FIG. 4 is a schematic view of relevant portions of a deposition apparatus according to a second embodiment and a third embodiment;

FIG. 5A and FIG. 5B are graphs showing exemplary characteristics of the deposition apparatus according to the second embodiment;

FIG. 6 is a graph showing exemplary characteristics of a deposition apparatus according to the third embodiment;

FIG. 7 is a schematic view of relevant portions of a deposition apparatus according to a fourth embodiment; and

FIG. 8 is a flowchart showing an example of a deposition method using the deposition apparatus according to the fourth embodiment.

### DETAILED DESCRIPTION

According to one embodiment, a deposition apparatus includes a plasma gun, a detector, and a controller. The plasma gun is capable of ejecting a plasma gas, and is capable of forming a film on a work piece exposed to the plasma gas. The detector detects a temperature or a luminous intensity in the plasma gas in a direction of ejection of the plasma gas. The controller controls a distance between the work piece and the plasma gun based on the temperature or the luminous intensity obtained from the detector, so that the plasma gas has a temperature in a range from a first temperature to a second temperature or a luminous intensity in a range from a first luminous intensity to a second luminous intensity is irradiated to the work piece.

Various embodiments are described hereinafter with reference to the accompanying drawings.

The drawings are schematic or conceptual, and do not necessarily reflect actual scale such as the relationship between the thickness and width of a component, and the proportions of component sizes. It should also be noted that the dimensions or proportions of the components in the drawings are not necessarily the same even when referring to the same component.

In the specification and the appended figures, the same or similar elements are indicated by the same reference label, and detailed descriptions of such components are omitted as appropriate.

### First Embodiment

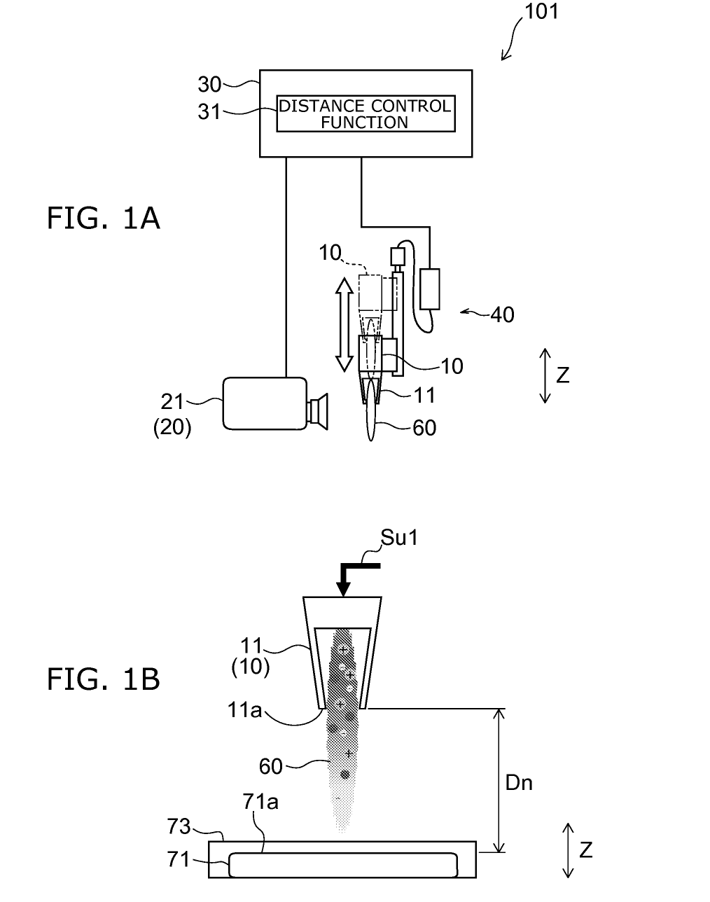

FIG. 1A and FIG. 1B are schematic views of relevant portions of a deposition apparatus according to a first embodiment.

FIG. 2 is a schematic view of a relevant portion of the deposition apparatus according to the first embodiment.

FIG. 1B is a schematic cross sectional view of the deposition apparatus (here and below, plasma deposition apparatus 101, for example). FIG. 2 is a schematic view of a plasma gas 60 ejected from the deposition apparatus 101. FIG. 1A and FIG. 1B, and FIG. 2 show a cross section of a nozzle 11.

As shown in FIG. 1A, the deposition apparatus 101 according to the embodiment includes a plasma gun 10, a detector 20, and a controller 30.

The plasma gun 10 ejects a plasma gas 60. The plasma gun 10 is capable of forming a film by exposing a work (work piece) with the plasma gas 60 at a position to which the plasma gas 60 is directed (for example, directly below the plasma gun 10). Examples of the work piece include semiconductor substrates, and machine components. The plasma gun 10 has a nozzle 11. The plasma gas 60 is ejected through the nozzle 11. In the embodiment, the work piece is a component 71. A film is formed on a surface 71a of the component 71.

In the embodiment, the plasma gun 10 is provided so as to be freely movable in Z-direction (vertical direction). The plasma gun 10 moves, for example, 500 mm (millimeters) in Z-direction relative to a reference point. That is, the plasma gun 10 is displaceable in Z-direction. The deposition apparatus 101 also includes a gun moving section 40. The gun moving section 40 moves the plasma gun 10. The gun moving section 40 is controlled by, for example, the controller 30.

The gun moving section 40 has an actuator as the power source for moving the plasma gun 10. Examples of the actuator include a stepping motor, and a serve motor. The controller 30 inputs, for example, a predetermined pulse number to the driver of the actuator. This drives the actuator, and moves the plasma gun 10 in units of, for example, micrometers (μm), enabling adjusting the Z-direction position of the plasma gun 10. On a deposition, the distance between the ejection orifice 11a of the nozzle 11 of the plasma gun 10 and the surface 71a of the component 71 (hereinafter, “spray distance Dn”) is adjusted, as shown in FIG. 1B.

As shown in FIG. 1B, an assisting gas (carrier gas) for assisting plasma formation, a spray material for forming a film 73, and power are supplied to the plasma gun 10 (see arrow Su1 in FIG. 1B), among other things. Examples of the spray material include SiC (silicon carbide), or Y₂O₃ (yttrium oxide). The spray material is in the form of, for example, a powder or a slurry. The spray material collides with the surface 71a of the component 71, and forms the film 73.

When the spray material is SiC, the film 73 has, for example, a cubic (3C-SiC), or a hexagonal (4H-SiC, 6H-SiC) crystalline structure. The characteristics of the film 73 (for example, thermal conductivity, corrosive properties) depend on its crystalline structure. The crystalline structure of the film 73 varies with, for example, deposition temperature.

As shown in FIG. 2, the plasma gas 60 has a temperature distribution along the ejection direction of the plasma gas 60. The temperature of the plasma gas 60 is a factor that varies the quality of the deposited film. Film quality as used herein means the crystallinity and the orientation of the deposited film. The temperature of the plasma gas 60 decreases toward the tip side. The plasma gas 60 has, for example, 5000° C., 3000° C., and 2000° C. temperature regions.

The detector 20 detects the state of the plasma gas 60. The state of plasma gas 60 as used herein means either the temperature of the plasma gas 60 or the luminous intensity of the plasma gas 60.

The detector 20 includes a temperature detector 21. The temperature detector 21 detects temperature as a state of the plasma gas 60. The temperature detector 21 includes, for example, a non-contact-type temperature sensor (for example, a temperature monitor).

The controller 30 may monitor the temperature of the plasma gas 60 with the temperature monitor, and activate an alarm to notify an apparatus malfunction when the temperature of the plasma gas 60 does not reach a preset temperature. In the case of such malfunction, the work piece is not irradiated with the plasma gas 60. That is, the deposition process is not performed. Here, the preset temperature may be, for example, room temperature.

The controller 30 adjusts the spray distance Dn by using the state of plasma gas 60 detected by the detector 20.

The controller 30 is, for example, a CPU (Central Processing Unit) of a computer. The controller 30 executes predetermined programs to realize each of units, as described below.

The controller 30 has a distance control unit 31.

The distance control unit 31 obtains from the controller 30 a target distance Tn1 needed to achieve the predetermined deposition temperature, based on the temperature of plasma gas 60 detected by the temperature detector 21, and moves the plasma gun 10 with the gun moving section 40 to bring the distance Dn to the target distance Tn1.

The distance control unit 31 makes the temperature detector 21 detect the temperature of plasma gas 60 while moving and sequentially varying the Z-direction position of the plasma gun 10 with the gun moving section 40. This creates a temperature distribution of the plasma gas 60, that is, the correspondence between Z-direction positions of the plasma gun 10 and temperatures of the plasma gas 60 is created.

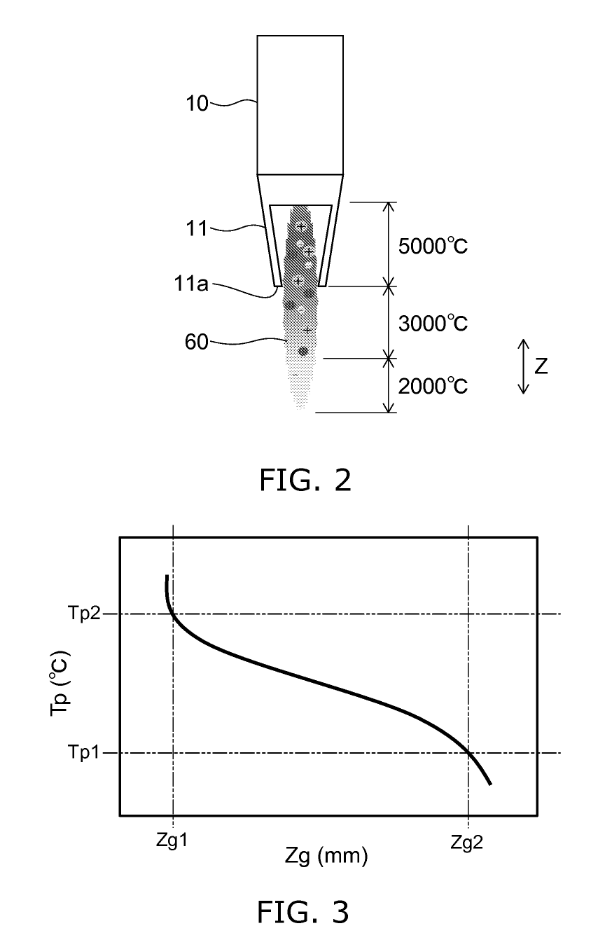

FIG. 3 is a graph showing exemplary characteristics of the deposition apparatus according to the first embodiment.

FIG. 3 is an example of a temperature distribution of the plasma gas 60. In FIG. 3, the horizontal axis represents Z-direction position Zg (mm) from the plasma gun 10, and the vertical axis represents temperature Tp (° C.). In other words, position Zg (mm) corresponds to a distance from the ejection orifice 11a of the nozzle 11.

The distance control unit 31 records Z-direction positions of the plasma gun 10 in a range (Zg1 to Zg2; hereinafter, “first range”) in which the temperature of the plasma gas 60 falls within a temperature range (between first temperature Tp1 and second temperature Tp2) that has been preset in the distance control unit 31. Here, the temperature range is, for example, a temperature range that enables depositing a film of a predetermined crystalline structure. A temperature range that enables depositing a film of a 6H-SiC crystalline structure is, for example, 3000±100° C.

Based on the first range of plasma gun 10 obtained as above, the distance control unit 31 calculates the target distance Tn1 needed to deposit a film of a predetermined crystalline structure. The target distance Tn1 also may be calculated, for example, based on the average value of the first range of plasma gun 10 obtained as above. For example, the target distance Tn1 is half the distance that is the sum of Zg1 and Zg2.

The distance control unit 31 moves the plasma gun 10 with the gun moving section 40, and brings the distance Dn to the target distance Tn1.

An example of a deposition method using the deposition apparatus 101 according to the embodiment is described below. An assisting gas, a spray material, and power are supplied to the plasma gun 10 of the deposition apparatus 101, among other things. The plasma gas 60 is ejected through the nozzle 11.

The distance control unit 31 of the controller 30 notifies a pulse number of a stepping motor to the gun moving section 40, for example. In response, the plasma gun 10 moves up or down, varying its position along Z-direction. The distance control unit 31 measures the temperature of the plasma gas 60 with the temperature detector 21 along with the movement of the plasma gun 10. The measurements create a temperature distribution of the plasma gas 60, and the target distance Tn1 needed to achieve the predetermined deposition temperature is obtained based on the temperature distribution. Then, the distance control unit 31 moves the plasma gun 10 with the gun moving section 40, and brings the distance Dn to the target distance Tn1.

As described above, in the first embodiment, the target distance Tn1 is obtained, and the spray distance Dn is brought to the target distance Tn1 to enable depositing a film at the desired deposition temperature in each deposition. Thus, the embodiment reduces variation in the quality of the product film, and achieves a substantially uniform film quality, making it possible to improve the repeatability of the deposition. For example, the embodiment enables depositing a film of a desired crystalline structure (for example, 6H-SiC).

Alternatively, the distance Dn may be set to any distance between Zg1 and Zg2. Here, the distance Dn may be fixed in the range of from Zg1 to Zg2, or may be variable in this range.

### Second Embodiment

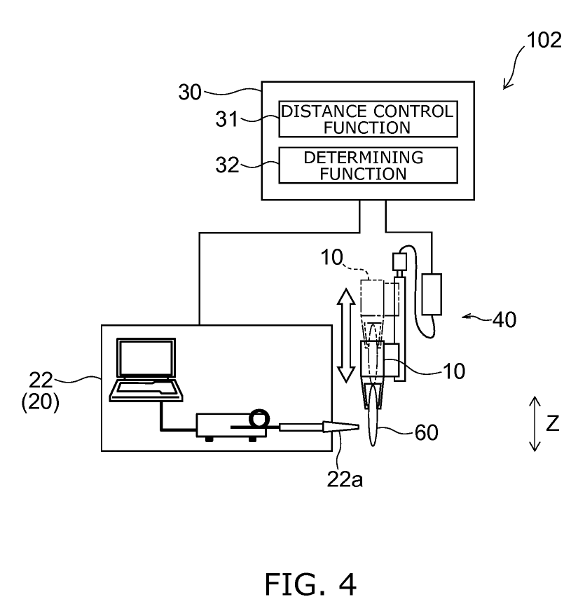

FIG. 4 is a schematic view of relevant portions of a deposition apparatus according to a second embodiment and a third embodiment.

As shown in FIG. 4, the deposition apparatus 102 according to the second embodiment (the third embodiment) includes a plasma gun 10, a detector 20, and a controller 30. The detector 20 further includes a luminous intensity detector 22. The controller 30 includes a determining unit 32, in addition to the distance control unit 31. The deposition apparatus 102 is no different from the deposition apparatus 101 except for the determining unit 32 of the controller 30.

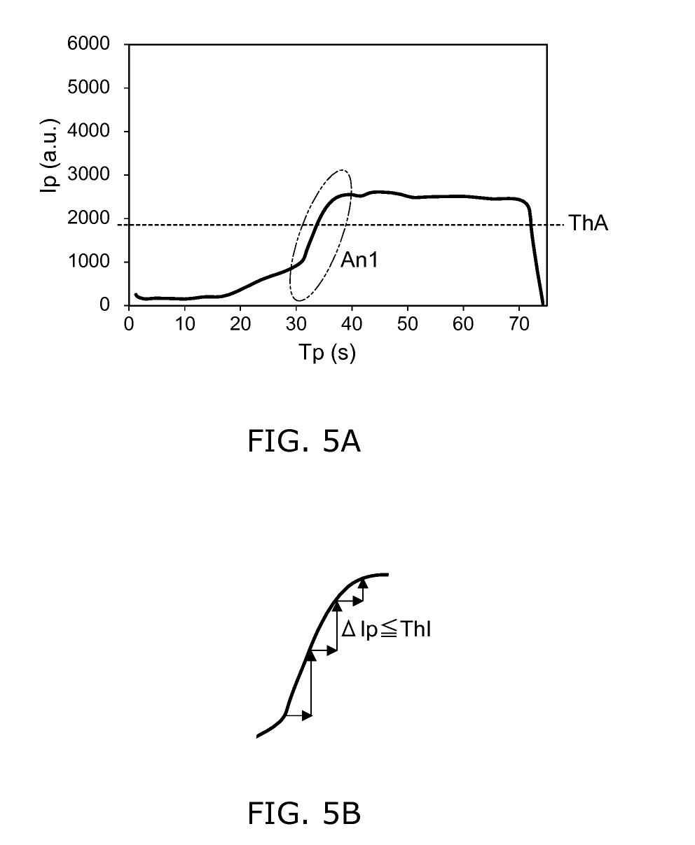

FIG. 5A and FIG. 5B are graphs showing exemplary characteristics of the deposition apparatus according to the second embodiment.

FIG. 5A shows the relationship between time Tp and luminous intensity Ip upon ejection of plasma gas 60. In FIG. 5A, the vertical axis represents luminous intensity Ip (A.U.: Arbitrary Unit), and the horizontal axis represents time Tp (s: seconds) from the start of ejection. In the example shown in FIG. 5A, power is supplied after about 8 s, and the assisting gas is supplied after about 18 s. FIG. 5B magnifies the portion An1 of FIG. 5A.

As shown in FIG. 5A, the luminous intensity of the plasma gas 60 is 1000 or less for a short while from the start of the supply of the assisting gas (about 18 s to about 30 s). The luminous intensity of the plasma gas 60 shows a sharp increase shortly after 30 s. The luminous intensity of the plasma gas 60 remains stable at about 2500 after about 35 s.

As shown above, it takes, for example, about several ten seconds for the luminous intensity of the plasma gas 60 to become stable from the start of power supply. For example, variation occurs in film quality when deposition is started before the plasma gas 60 reaches a stable state. For example, variation occurs in film thickness. In this case, stable deposition is not possible.

In the embodiment, the determining unit 32 of the controller 30 uses the luminous intensity detector 22 to determine whether the plasma gas 60 has reached a stable state or not, for example, before obtaining the target distance Tn1 and controlling the distance Dn in the manner described in the first embodiment. The following specifically describes the luminous intensity detector 22 and the determining unit 32.

The luminous intensity detector 22 detects luminous intensity as a state of the plasma gas 60. The luminous intensity detector 22 is, for example, a plasma process monitor that detects luminous intensity. In the embodiment, the luminous intensity detector 22 has a plasma luminescence probe 22a. Luminous intensity is detected, for example, for a predetermined position of the plasma gas 60.

The controller 30 may monitor the luminous intensity of the plasma gas 60 with the plasma process monitor, and activate an alarm to notify an apparatus malfunction when the luminous intensity of the plasma gas 60 does not reach the preset luminous intensity. In the case of such malfunction, the work piece is not irradiated with the plasma gas 60. That is, the deposition process is not performed.

The determining unit 32 determines whether the plasma gas 60 has reached a stable state or not, based on the luminous intensity detected by the luminous intensity detector 22.

The determining unit 32 monitors the luminous intensity detected by the luminous intensity detector 22 one after another, and determines that the plasma gas 60 has reached a stable state, for example, when the following two conditions are satisfied.

### First Condition:

The increase rate ΔIp of the luminous intensity of the plasma gas 60 per a predetermined time comes to be not more than the preset first threshold ThI, as shown in FIG. 5B.

### Second Condition:

The luminous intensity of the plasma gas 60 comes to be not less than the preset second threshold ThA (for example, 1900 or more in this example), as shown in FIG. 5A.

Upon determining that the plasma gas 60 has not reached a stable state, the determining unit 32 repeats the determination procedure after a predetermined time (for example, several milliseconds).

An example of a deposition method using the deposition apparatus 102 according to the embodiment is described below.

An assisting gas, a spray material, and power are supplied to the plasma gun 10 of the deposition apparatus 102, among other things. The plasma gas 60 is ejected through the nozzle 11.

Base on the luminous intensity detected by the luminous intensity detector 22, the determining unit 32 of the controller 30 determines whether the plasma gas 60 has reached a stable state or not. Upon determining that the plasma gas 60 has not reached a stable state, the determining unit 32 repeats the determination procedure after the predetermined time. The determining unit 32 ends the determination procedure upon determining that the plasma gas 60 has reached a stable state.

For example, the deposition process is started upon the plasma gas 60 being determined as stable. For example, the target distance Tn1 is obtained, and the distance Dn is controlled in the manner described in the first embodiment.

As described above, in the second embodiment, the determining unit 32 determines the stability of the plasma gas 60 based on the luminous intensity detected by the luminous intensity detector 22. This enables more stably forming a film. The second embodiment also further improves the repeatability of the deposition.

### Third Embodiment

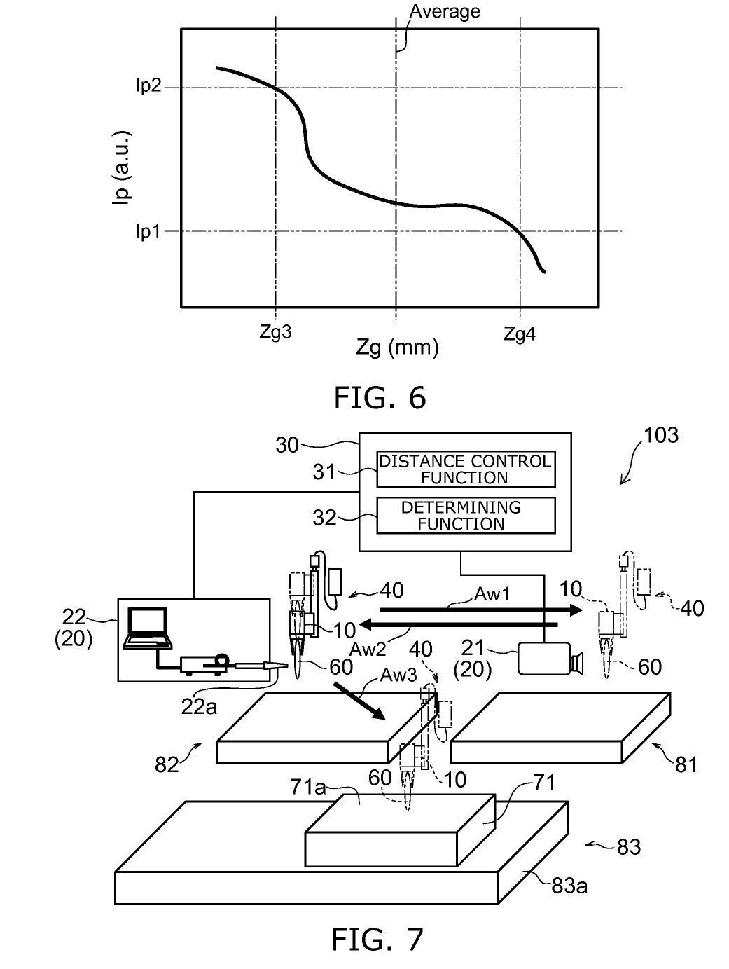

FIG. 6 is a graph showing exemplary characteristics of a deposition apparatus according to the third embodiment.

FIG. 6 shows the relationship between the Z-direction position of plasma gun 10 and the luminous intensity Ip of plasma gas 60. In FIG. 6, the vertical axis represents luminous intensity Ip (A.U.), and the horizontal axis represents the Z-direction position of plasma gun 10 (mm).

As shown in FIG. 6, the plasma gas 60 in a stable state has a luminous intensity distribution in the direction of ejection of the plasma gas 60.

As described above, the luminous intensity of the plasma gas 60 is related to the density and the dissociation state of the plasma gas 60. For example, the density of the plasma gas 60 is higher at a position where the luminous intensity is high, compared a position where the luminous intensity is low. The luminous intensity of the plasma gas 60 is a factor associated with the deposition rate of the film formed. For example, the deposition rate does not become substantially constant when there is variation in the density of the plasma gas 60. The thickness of the film 73 formed does not become substantially constant.

In the embodiment, the distance control unit 31 of the deposition apparatus 102 uses the luminous intensity of the plasma gas 60 detected by the luminous intensity detector 22, and obtains a target distance Tn2 needed to achieve a predetermined deposition rate. Specifically, for example, the distance control unit 31 makes the luminous intensity detector 22 detect the luminous intensity of the plasma gas 60 while moving and sequentially varying the Z-direction position of the plasma gun 10 with the gun moving section 40. This provides the correspondence between the Z-direction position of the plasma gun 10 and the luminous intensity of the plasma gas 60, specifically the luminous intensity distribution of the plasma gas 60. The distance control unit 31 records Z-direction positions of the plasma gun 10 in a range (Zg3 to Zg4; hereinafter, “second range”) in which the luminous intensity of the plasma gas 60 falls within a luminous intensity range (between first luminous intensity Ip1 and second luminous intensity Ip2) that has been preset in the distance control unit 31. Here, the luminous intensity range is, for example, a luminous intensity range that enables depositing a predetermined film at a predetermined deposition rate. A luminous intensity range that enables depositing a film at a predetermined deposition rate is, for example, Z±1 mm. To achieve this, the plasma gun 10 requires a high-resolution actuator (for example, a stepping motor, or a servo motor).

Based on the second range (Zg3 to Zg4) of plasma gun 10 obtained as above, the distance control unit 31 calculates the target distance Tn2 needed to deposit a film at a predetermined deposition rate. The target distance Tn2 also may be calculated, for example, based the average value of the second range (Zg3 to Zg4) of plasma gun 10 obtained as above. For example, the target distance Tn2 is half the distance that is the sum of Zg3 and Zg4.

An example of a deposition method using the deposition apparatus 102 according to the embodiment is described below.

An assisting gas is supplied to the plasma gun 10 of the deposition apparatus 102, among other things. The plasma gas 60 is ejected through the nozzle 11.

The distance control unit 31 of the controller 30 moves the plasma gun 10 up or down with the gun moving section 40 to vary the Z-direction position of the plasma gun. The distance control unit 31 measures the luminous intensity of the plasma gas 60 with the luminous intensity detector 22 along with the movement of the plasma gun 10. This provides a luminous intensity distribution of the plasma gas 60, and the target distance Tn2 needed to achieve the predetermined deposition rate is obtained from the luminous intensity distribution.

In the deposition process, the controller 30 moves the plasma gun 10 with the gun moving section 40, and adjusts the Z-direction distance of the plasma gun 10 to bring the spray distance Dn to the target distance Tn2 for deposition.

As described above, in the third embodiment, a predetermined deposition rate can be achieved by obtaining a target distance Tn2, and bringing the spray distance Dn to the target distance Tn2. This enables more stably forming a film. The third embodiment also further improves the repeatability of deposition.

Alternatively, the distance Dn may be set to any distance between Zg3 and Zg 4. Here, the distance Dn may be fixed in the range of from Zg3 to Zg4, or may be variable in this range.

### Fourth Embodiment

FIG. 7 is a schematic view of relevant portions of a deposition apparatus according to a fourth embodiment.

FIG. 7 is an overall perspective view schematically showing the deposition apparatus 103 according to the embodiment.

As shown in FIG. 7, the deposition apparatus 103 includes a plasma gun 10, a detector 20, and a controller 30. The deposition apparatus 103 further includes a plasma temperature sensor unit 81, a plasma luminescence monitor unit 82, a coating unit 83, and a transporting robot (not shown) that moves the plasma gun 10 to these units.

The detector 20 includes a temperature detector 21, and a luminous intensity detector 22.

The controller 30 includes a distance control unit 31, and a determining unit 32.

The temperature sensor 21 is provided for the plasma temperature sensor unit 81. The luminous intensity detector 22 is provided for the plasma luminescence monitor unit 82. The coating unit 83 has a mount 83a on which a member 71 is set and a film is deposited (coated). The transporting robot moves the plasma gun 10 between each unit. The transporting robot is controllable by, for example, the controller 30.

As shown in FIG. 7, the plasma temperature sensor unit 81 is disposed adjacent the plasma luminescence monitor unit 82 and the coating unit 83. The plasma luminescence monitor unit 82 is disposed adjacent the coating unit 83.

The plasma temperature sensor unit 81 measures the temperature of the plasma gas 60 ejected from the plasma gun 10. The plasma luminescence monitor unit 82 measures the luminous intensity of the plasma gas 60 ejected from the plasma gun 10. The coating unit 83 deposits a film on the member 71.

The distance control unit 31 of the controller 30 obtains a target distance Tn3 by using the temperature and the luminous intensity of the plasma gas 60. The spray distance Dn is brought to the target distance Tn3. In this way, a substantially constant film quality can be obtained in the resulting film. A substantially constant film thickness can be obtained in the resulting film. The repeatability of deposition further improves.

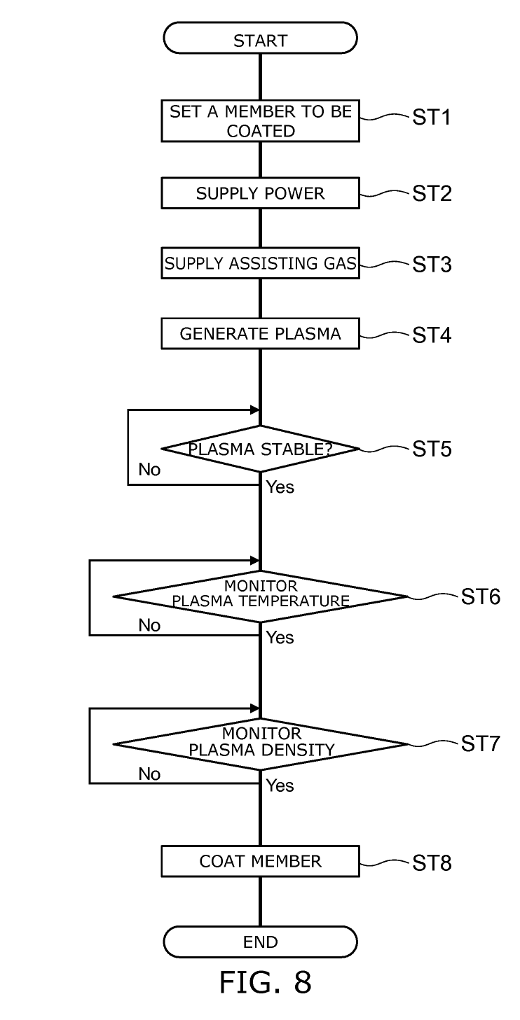

An example of a deposition method using the deposition apparatus 103 is described below with reference to FIG. 8.

FIG. 8 is a flowchart showing an example of a deposition method using the deposition apparatus according to the fourth embodiment.

The member 71 to be coated is set on the mount 83a of the deposition apparatus 103 (first step ST1).

The plasma gun 10 is moved to the plasma luminescence monitor unit 82 in advance. Power is supplied to the plasma gun 10 (second step ST2). An assisting gas and the like are supplied to the plasma gun 10 (third step ST3). This generates the plasma gas 60, and the plasma gas 60 is ejected through the nozzle 11 (fourth step ST4).

The determining unit 32 of the controller 30 monitors the luminous intensity of the plasma gas 60 with the luminous intensity detector 22, and determines whether the plasma gas 60 has reached a stable state or not. (fifth step ST5). This step may be omitted, as appropriate. Upon determining that the plasma gas 60 has not reached a stable state, the determining unit 32 repeats the determination procedure after the predetermined time (for example, several milliseconds). The determining unit 32 ends the determination procedure upon determining that the plasma gas 60 has reached a stable state.

Upon the plasma gas 60 being determined as stable, the plasma gun 10 is moved to the plasma temperature sensor unit 81. (see arrow Awl in FIG. 7).

The distance control unit 31 of the controller 30 moves the plasma gun 10 with the gun moving section 40, and uses the temperature detector 21 to determine whether the temperature of the plasma gas 60 is within the temperature range that has been preset in the distance control unit 31 (sixth step ST6) or not. The first range (Zg1 to Zg2) of the plasma gun 10 is recorded.

The plasma gun 10 is moved to the plasma luminescence monitor unit 82 (see arrow Awl in FIG. 7).

The distance control unit 31 of the controller 30 moves the plasma gun 10 with the gun moving section 40, and uses the luminous intensity detector 22 to determine whether the luminous intensity of the plasma gas 60 is within the luminous intensity range that has been preset in the distance control unit 31 (seventh step ST7) or not. The second range (Zg3 to Zg4) of the plasma gun 10 that falls within the first range and in which the luminous intensity of the plasma gas 60 is within the luminous intensity range that has been preset in the distance control unit 31 is recorded. The second range is contained in the first range. The plasma gun 10 may be moved within the first range.

From the first range and the second range, the distance control unit 31 of the controller 30 calculates the target distance Tn3 needed to deposit a film of a predetermined crystalline structure at a predetermined deposition rate. The target distance Tn3 is calculated, for example, by using the average value of the second range of plasma gun 10 obtained as above.

The plasma gun 10 is moved to the coating unit 83 (see arrow Aw3 in FIG. 7).

The controller 30 moves the plasma gun 10 with the gun moving section 40, and adjusts the Z-direction distance of the plasma gun 10 to bring the spray distance Dn to the target distance Tn3. The member is coated (eighth step ST8, deposition process).

As described above, in the fourth embodiment, the target distance Tn3 is obtained, and the spray distance Dn is brought to the target distance Tn3 to enable depositing a film of a predetermined crystalline structure at a predetermined deposition rate. A substantially constant film quality and film thickness can thus be obtained in the resulting film. The fourth embodiment also further improves the repeatability of deposition.

When deposition is to be continuously performed on another member following the previous deposition, the plasma gas 60 may be kept ejected while the new member is being set on the mount 83a, or the ejection may be suspended during this period. When suspending and resuming the ejection of the plasma gas 60, the first step ST1 may be performed again to check whether the plasma gas 60 has reached a stable state or not.

For example, the third step ST3 to the eighth step ST8 are automatically performed by the controller 30.

The sixth step ST6 and the seventh step ST7 may be performed every time before the eighth step ST8 (deposition process), or the eighth step ST8 (deposition process) may be performed with the target distance Tn3 that has been obtained beforehand by performing the sixth step ST6 and the seventh step ST7 under predetermined conditions.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in deposition apparatuses such as plasma guns, detectors, controllers, etc., from known art. Such practice is included in the scope of the invention to the extent that similar effects thereto are obtained.

Further, any two or more components of the specific examples combined within the extent of technical feasibility, namely, working examples complexing at least two of the first to fourth embodiments are included in the scope of the invention to the extent that the purport of the invention is included.

Moreover, all deposition apparatuses practicable by an appropriate design modification by one skilled in the art based on the deposition apparatuses described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A deposition apparatus comprising:
a plasma gun being capable of ejecting a plasma gas, and being capable of forming a film on a work piece exposed to the plasma gas;
a detector detecting a temperature or a luminous intensity in the plasma gas in a direction of ejection of the plasma gas; and
a controller controlling a distance between the work piece and the plasma gun based on the temperature or the luminous intensity obtained from the detector, so that the plasma gas having a temperature in a range from a first temperature to a second temperature or a luminous intensity in a range from a first luminous intensity to a second luminous intensity being irradiated to the work piece.

2. The apparatus according to claim 1, wherein
the controller controls a distance between the work piece and the plasma gun based on the temperature and the luminous intensity obtained from the detector, so that the plasma gas having a temperature in a range from a first temperature to a second temperature and a luminous intensity in a range from a first luminous intensity to a second luminous intensity being irradiated to the work piece.

3. The apparatus according to claim 1, wherein
the work piece is exposed to the plasma gas at a halfway point between a first position and a second position, the temperature at the first position is the first temperature, and the temperature at the second position is the second temperature.

4. The apparatus according to claim 1, wherein
the work piece is exposed to the plasma gas at a halfway point between a first position and a second position, the luminous intensity at the first position is the first luminous intensity, and the luminous intensity at the second position is the second luminous intensity.

5. The apparatus according to claim 1, wherein
the controller controls the distance after the plasma gas reaches a stable state.

6. The apparatus according to claim 5, wherein
the controller controls the distance when a increase rate of the luminous intensity of the plasma gas per a predetermined time period is not more than a first threshold and when the luminous intensity of the plasma gas is not less than a second threshold.

7. The apparatus according to claim 1, wherein
the detector includes a temperature monitor detecting the temperature of the plasma gas, and
the controller detects the temperature of the plasma gas with the temperature monitor, and controls not to irradiate the plasma gas to the work piece when the temperature of the plasma gas does not reach a set temperature.

8. The apparatus according to claim 1, wherein
the detector includes a plasma process monitor detecting the luminous intensity of the plasma gas, and
the controller detects the luminous intensity of the plasma gas with the plasma process monitor, and controls not to expose the plasma gas to the work piece when the luminous intensity of the plasma gas detected by the plasma process monitor does not reach a set luminous intensity.

9. The apparatus according to claim 1, wherein
the detector includes a temperature sensor.

10. The apparatus according to claim 1, wherein
the detector includes a plasma luminescence probe.

11. A deposition method comprising:
obtaining a temperature distribution or a luminous intensity distribution in the plasma gas in a direction of an ejection of plasma gas, the plasma gas being ejected from a plasma gun;
adjusting a distance between a work piece and the plasma gun based on the temperature distribution or the luminous intensity distribution before forming a film on the work piece exposed to the plasma gas, so that the plasma gas having a temperature in a range from a first temperature to a second temperature or a luminous intensity in a range from a first luminous intensity to a second luminous intensity being irradiated to the work piece; and
forming a film on the work piece by irradiating the plasma gas to work piece at the adjusted distance.

12. The method according to claim 11, wherein
the distance between the work piece and the plasma gun is adjusted by using the temperature distribution and the luminous intensity distribution before forming the film on the work piece exposed to the plasma gas, so that the plasma gas having a temperature in a range from a first temperature to a second temperature and a plasma gas luminous intensity in a range from a first luminous intensity to a second luminous intensity being irradiated to the work.

13. The method according to claim 11, wherein
the work piece is exposed to the plasma gas at a halfway point between a first position and a second position, the temperature at the first position is the first temperature, and the temperature at the second position is the second temperature.

14. The method according to claim 11, wherein
the work piece is exposed to the plasma gas at a halfway point between a first position and a second position, the luminous intensity at the first position is the first luminous intensity, and the luminous intensity at the second position is the second luminous intensity.

15. The method according to claim 11, wherein
the temperature distribution or the luminous intensity distribution is obtained after the plasma gas ejected from the plasma gun reaches a stable state.

16. The method according to claim 15, wherein
the distance is controlled when a increase rate of the luminous intensity of the plasma gas per a predetermined time period is not more than a first threshold and when the luminous intensity of the plasma gas is not less than a second threshold.

17. The method according to claim 11, wherein
the temperature of the plasma gas is detected with a temperature monitor, and the work piece is not irradiated with the plasma gas when the temperature of the plasma gas does not reach a set temperature.

18. The method according to claim 11, wherein
the luminous intensity of the plasma gas is detected with a plasma process monitor, and the work piece is not irradiated with the plasma gas when the luminous intensity of the plasma gas does not reach a set luminous intensity.
